(19) United States
(12) Patent Application Publication
(10) Pub. No.: US 2025/0390773 A1
(43) Pub. Date: Dec. 25, 2025

(54) ANSATZ TENSOR NETWORK REDUCTION

(71) Applicant: Dell Products L.P., Round Rock, TX (US)

(72) Inventors: Miguel Paredes Quiñones, Campinas (BR); João Victor Da Fonseca Pinto, Rio de Janeiro (BR); Micael Veríssimo de Araújo, Rio de Janeiro (BR)

(21) Appl. No.: 18/752,159

(22) Filed: Jun. 24, 2024

(51) Int. Cl. G06N 10/20; G06N 3/082; G06N 7/01

(52) U.S. Cl. CPC G06N 10/20; G06N 3/082; G06N 7/01

(57) ABSTRACT

Techniques for using AI to reduce a tensor network are disclosed. A service receives an ANSATZ model that is structured as a DAG. This input DAG includes nodes and edges. The service receives a vector reflective of an optimization problem. The optimization problem identifies parameters related to the ANSATZ model. The service feeds the input DAG and the vector as input to the ML algorithm. The ML algorithm attempts to optimize the parameters by assigning probabilities to the nodes and edges. The probabilities reflect whether corresponding tensors will be included in an output ANSATZ DAG. The service receives an output ANSATZ DAG from the ML algorithm. The service then applies a probability threshold to the output ANSATZ DAG, resulting in removal of nodes and edges from the output ANSATZ DAG.

### COPYRIGHT AND MASK WORK NOTICE

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### TECHNOLOGICAL FIELD OF THE DISCLOSURE

Embodiments disclosed herein generally relate to optimizing functions. More particularly, at least some embodiments relate to systems, hardware, software, computer-readable media, and methods for using machine learning to decrease overparameterization so as to determine which gates of a quantum circuit are of relatively higher importance and to cull the lesser important gates from the circuit.

### BACKGROUND

A “tensor network” is a class or a type of variational wave function. These types of functions are often used to evaluate multi-body quantum systems. One benefit of a tensor network is that the tensor network can extend a single dimensional matrix state to a higher dimensional state. This extension is performed while preserving the mathematical characteristics and features of the original matrix state.

Recently, tensor networks have been improved so as to be implemented to interact with supervised machine learning models. This interaction is achieved by the tensor network being configured to use the mathematical structures in quantum mechanics and machine learning. One of the primary interests in employing tensor networks to machine learning and quantum computing scenarios is the potential to reduce the number of parameters that are involved when approximating a higher order tensor from lower order tensors.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 illustrates an example computing architecture in which a service is tasked with generating a compressed representation of a quantum circuit via the usage of artificial intelligence (AI) having the objective to reduce a tensor network that represents the quantum circuit.

FIG. 2 illustrates how a tensor network can be used to represent a quantum circuit.

FIG. 3 illustrates an example contraction operation.

FIG. 4 illustrates an isometry and a disentangler.

FIG. 5 illustrates a random MERA ANSATZ.

FIG. 6 illustrates an example architecture of a graph neural network.

FIG. 7 illustrates a flowchart of an example method for using machine learning to decrease overparameterization (which often occurs in quantum computing) to better represent which gates are necessary or of relatively higher importance when attempting to solve a machine learning training problem.

FIG. 8 illustrates an example computer system that can be configured to perform any of the disclosed operations.

### DETAILED DESCRIPTION

Tensor networks help to simulate quantum circuits in a fast and efficient manner by performing approximations on the intermediate steps on a circuit's output calculation and by optimizing which operations are to be done first. One of the applications of tensor networks is the creation of pre-defined parameterizable tensor networks (ANSATZ) that are relatively easier to compute for a given set of parameters. The term “ANSATZ” refers to the use of a derived assumption to help solve a complex problem. That is, the derived assumption helps simplify certain parameters of the problem, so the overall problem becomes less complex.

Normally, the structure of a general ANSATZ permits wider entanglement and rotations along all axes on separate quantum bits (aka “qubits”). These entanglements and rotations allow the overarching system to encode multiple possible solutions on the domain of a problem. Then, for a given set of parameters, it becomes possible to approximate the expected value of the optimization problem that is to be solved. These ANSATZ structures are usually used in machine learning or optimization in quantum computing.

The disclosed embodiments bring about numerous benefits, advantages, and practical applications to machine learning and quantum computing. For instance, the disclosed embodiments are directed to various techniques that use machine learning to decrease overparameterization (which often occurs in quantum computing) to better represent which gates are necessary or of relatively higher importance when solving an optimization or machine learning training problem. Additionally, the disclosed embodiments are beneficially structured to facilitate the improved design of a dataset that is used to train the model. Accordingly, these and numerous other benefits will now be described in more detail throughout the remaining portions of this disclosure.

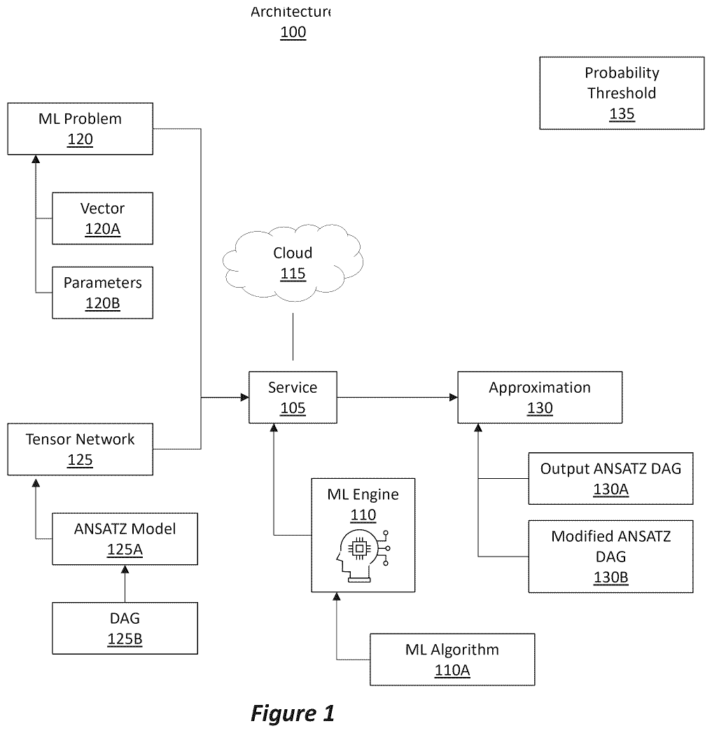

Attention will now be directed to FIG. 1, which illustrates an example architecture 100 in which the disclosed principles may be employed. Architecture 100 shows a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine (e.g., ML engine 110). The ML engine 110 enables service 105 to operate even when faced with a randomization factor, and the ML engine 110 can be used to perform quantum computing. The ML engine 110 can include any type of ML algorithm 110A.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 115 environment. In some implementations, service 105 is a local service operating on a local device. In some implementations, service 105 is a hybrid service that includes a cloud component operating in the cloud and a local component operating on a local device. These two components can communicate with one another.

Service 105 is generally tasked with using machine learning to decrease overparameterization to better represent which gates are necessary or of relatively higher importance to solve the optimization or machine learning training problem 120. Thus, as shown in FIG. 1, service 105 is provided access to an ML problem 120 and to a tensor network 125.

The ML problem 120 can be represented in vector form, as shown by the vector 120A. Also, the ML problem 120 (i.e. an “optimization problem”) identifies one or more parameters 120B related to the tensor network 125.

More specifically, the tensor network 125 can be structured as an ANSATZ model 125A, which can be structured to have the form of a directed acyclic graph, as shown by DAG 125B. Thus, service 105 is able to receive a vector 120A reflective of an optimization problem (e.g., ML problem 120) that is to be solved by a machine learning (ML) algorithm 110A. The optimization problem identifies one or more parameters 120B related to the ANSATZ model 125A, and the optimization problem relates to optimizing the one or more parameters 120B.

As will be described in more detail shortly, service 105 uses these inputs to generate an approximation 130 of the ML problem 120. That is, service 105 is able to use the tensor network 125 to reduce the representation of some tensors in lower orders, thereby enabling certain warranties on the resulting approximation 130 of the ML problem 120.

The approximation 130 can include an output ANSATZ DAG 130A, which can be further culled or pruned to remove certain edges and nodes that are determined to have probabilities that are lower than a threshold probability. After removal of these nodes and edges, a modified ANSATZ DAG 130B is produced, where the modified ANSATZ DAG 130B is less complex, thereby simplifying the ML problem 120.

By way of further clarification, service 105 feeds the input ANSATZ DAG (e.g., the ANSATZ model 125A) and the vector 120A as input to the ML algorithm 110A. Feeding the input ANSATZ DAG and the vector to the ML algorithm triggers the ML algorithm 110A to attempt to optimize the one or more parameters 120B by assigning, using the vector 120A, probabilities to the nodes and of edges in the input ANSATZ DAG (e.g., DAG 125B). The probabilities reflect whether corresponding tensors will be included in an output ANSATZ DAG 130A generated by the ML algorithm. Service 105 then receives the output ANSATZ DAG 130A from the ML algorithm. Service 105 then applies a probability threshold 135 to the output ANSATZ DAG 130A, resulting in removal of one or more nodes and one or more edges from the output ANSATZ DAG 130A. The removed nodes and edges are removed as a result of those removed nodes and edges having probabilities that are below the probability threshold 135. This removal process results in generation of the modified ANSATZ DAG 130B, which now includes fewer nodes and edges than the input ANSATZ DAG and which facilitates a more efficient ability to solve the ML problem 120. The modified ANSATZ DAG 130B can then be subjected to another ML operation in an attempt to solve the ML problem 120.

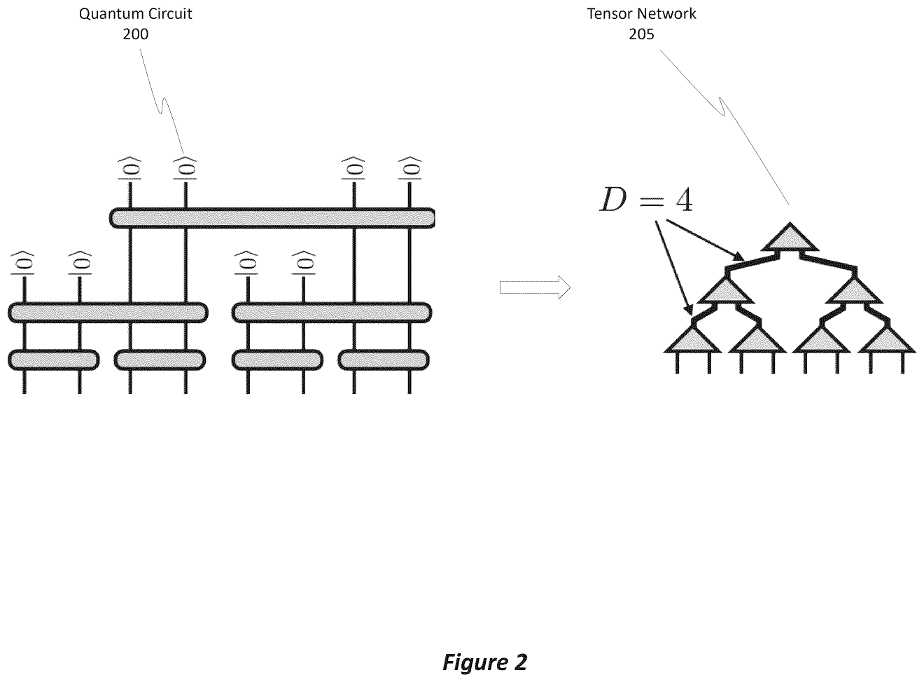

Turning briefly to FIG. 2, FIG. 2 shows a quantum circuit 200. FIG. 2 also shows how a tensor network 205, which corresponds to the tensor network 125 of FIG. 1, can be used to represent the quantum circuit 200. Quantum circuit 200 is shown as including “n” qubits with a corresponding number of nodes in the tensor network 205.

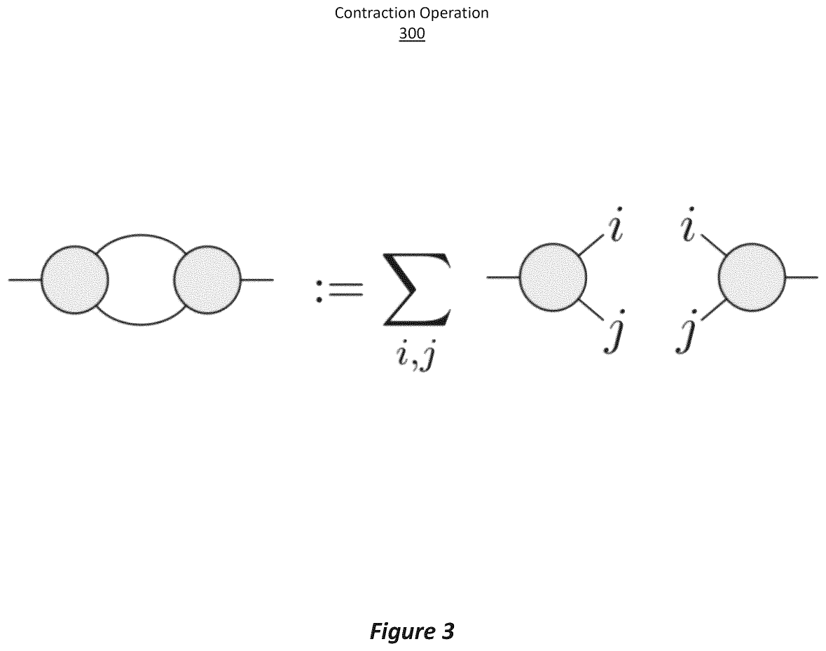

As mentioned previously, a tensor network is a multidimensional way that can be used to represent arrays of numbers. Lower dimensional instances can be scalar, vector, and/or matrices. One of the operations between tensors of compatible dimensions is the “contraction” operation. For instance, tensor networks can be viewed as being a sequence of contractions of different tensors. The contraction operation corresponds to a tensor product followed by a trace between indices of two tensors. This operation is widely used to reduce terms in tensors by making the computations more efficient. FIG. 3 illustrates an example contraction operation 300 in which the indices “i” and “j” will be reduced.

Representing the tensor network using operations, such as contractions, allows for the optimization of the gate operations due to relatively high representability and flexibility involved with those operations. By using this technique, it is possible to make efficient simulation of quantum circuits due to the possibility to represent them as tensor networks. One technique for developing the best contraction path for a tensor network is described below.

Variational quantum algorithms (VQAs) are a family of quantum algorithms that aim to find the optimal solution to an optimization problem by iteratively updating the parameters of a quantum circuit. These algorithms are often used in the context of quantum machine learning and optimization, where they can be used to find the best parameters for a quantum circuit that can solve a given problem.

Tensor networks are a mathematical framework that can be used to represent and manipulate high-dimensional tensors, which are objects with multiple indices. In the context of quantum computing, tensor networks can be used to represent quantum states and operations in a compact and efficient way.

VQAs can be combined with tensor networks to create more powerful algorithms for solving optimization problems. In these algorithms, the quantum circuit is represented using a tensor network, and the parameters of the circuit are updated using a variational optimization method, such as gradient descent.

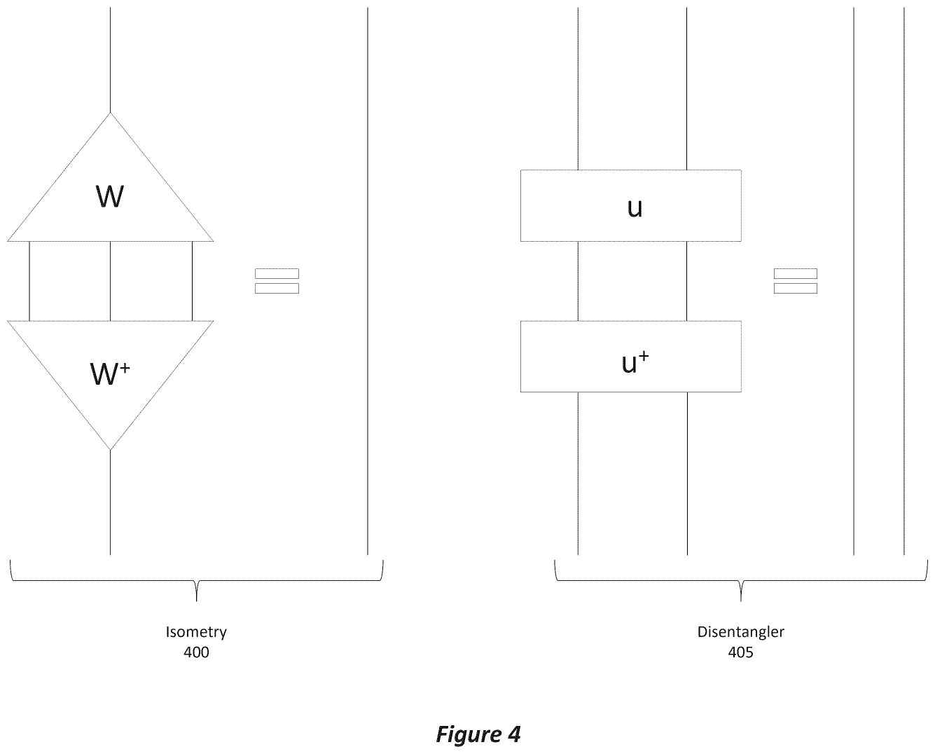

Multiscale Entanglement Renormalization Ansatz (MERA) is a type of tensor network that is structured to understand quantum many-body systems. MERA is considered an ANSATZ because its components are parametrized. MERA is a hierarchical tensor network that can be used to represent the ground states of one-dimensional (1D) and two-dimensional (2D) quantum many-body systems. A MERA tensor network is constructed by repeatedly applying a simple tensor called a “disentangler” to a block of neighboring quantum spins, followed by an “isometry” that maps the disentangled block onto a coarser grid. FIG. 4 shows an example of an isometry 400 and a disentangler 405.

With enough parameters, it is possible to map the Hilbert space of the tensor network to obtain a good enough solution given this set of parameters. Hilbert space is a vector space that is provided with an inner product. This inner product induces or triggers a distance function for which the defined Hilbert space is viewed as being a complete or full metric space. The problem arises because more parameters imply the addition of more control or single qubit gates, which are limited due to hardware constraints on the number of ports that can execute. As such, it is desirable to optimize these ANSATZ structures.

Multiple types of problems can be solved using ANSATZ. These problems can be encoded as Hamiltonians. It is possible to extract characteristics from the Hamiltonian, where these characteristics characterize the type of problem that is desired to be solved. Service 105 from FIG. 1 can determine the new ANSATZ that best suits the Hamiltonian (“H”). Metrics from H will be stored in a vector structure “m”. Metrics that can help represent the Hamiltonian can be used as statistics of its components, such as density, mean, variance, and so on.

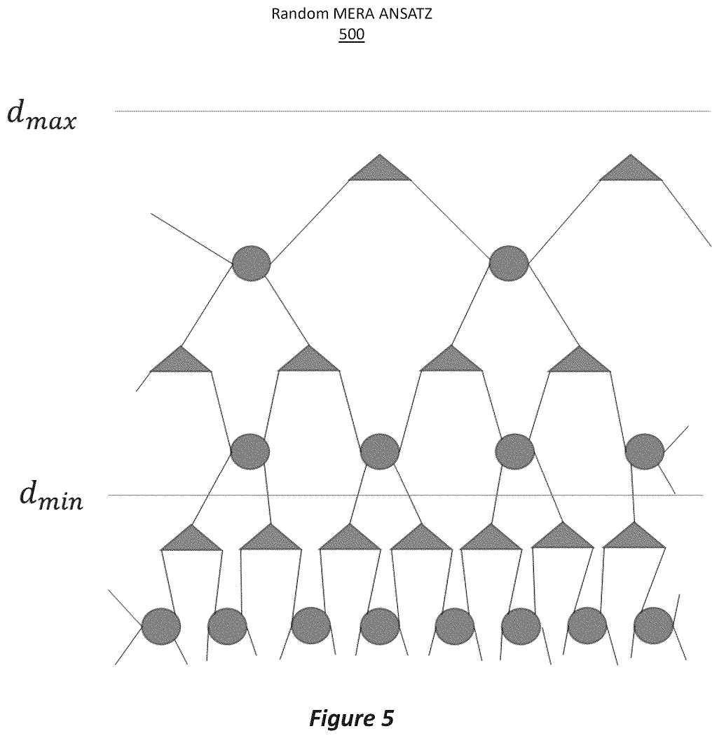

Service 105 is further structured to use different configurations of an ANSATZ (“A”) based on variations of hyper-parameters of variational structures. Considering the example of creating different MERA ANSATZ for different depths, service 105 can define a minimum (e.g., “d_min”) and a maximum depth to vary d_(max) as shown in FIG. 5. That is, FIG. 5 shows a random MERA ANSATZ 500 having a depth between the maximum and the minimum for the dataset generation. Then, service 105 can run a new ANSATZ “(A′”) that minimizes the energy of the Hamiltonian H after the optimization and contraction processes.

Service 105 can further collect data characteristics of the optimization problems in structure m (e.g., the number of variables, connectivity matrix of the optimization problem, etc.), and the original ANSATZ A and its final optimal version ANSATZ A′. Service 105 can store just the structure and some tensor/wire properties of ANSATZ A. As such, service 105 can represent that data in the form of a Direct Acyclic structure (DAG) D. One objective of service 105 will be another DAG D′ that only contains 0 or 1 (or potentially values in between) on the node attributes (e.g., 0 if it is not in a final structure A′ and 1 if it is in A′) to represent the final structure of A′.

For the sake of simplicity on the construction of the dataset and the possibility of a machine learning model learning patterns on the contraction process, it is often desirable to use an ANSATZ (e.g., like MERA) or some other efficient structure. Finally, the tuple (D, m, D′) is an entry on dataset S. The model can then be trained.

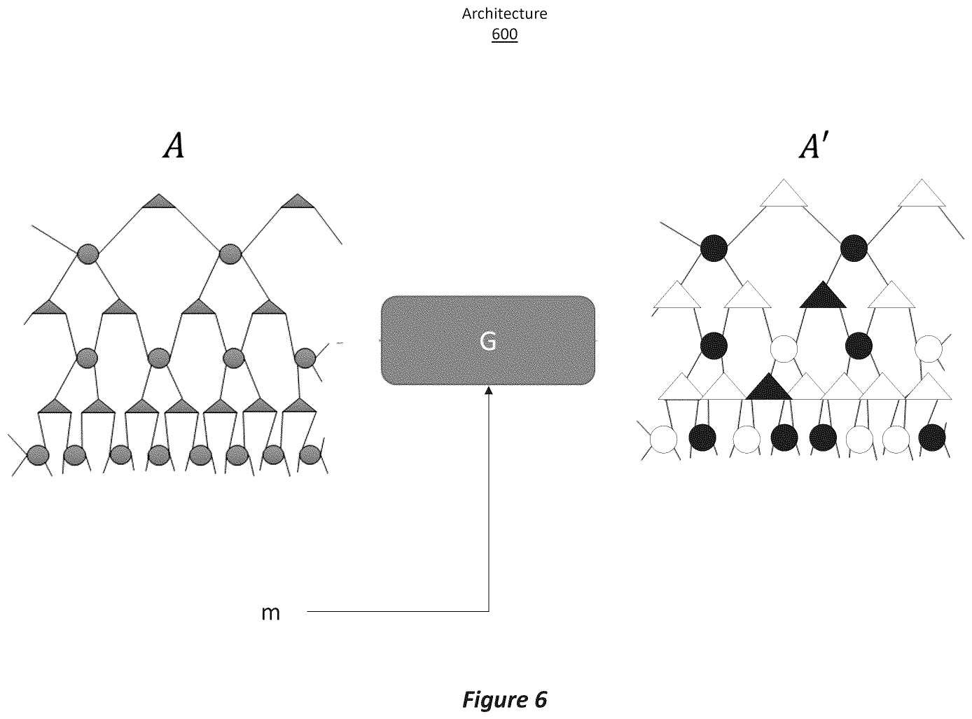

In the training phase, a graph neural network G(m, D) receives data from the original ANSATZ A in the form of a DAG D and characteristics of the optimization problem on the vector structure “m,” which was described earlier. The architecture of the graph neural network that is devised herein is depicted in FIG. 6, as shown by architecture 600.

In FIG. 6, one can observe how a DAG is an input of the graph neural network, which will convert this to a new structure in DAG by giving probabilities on the existence of tensors on the final ANSATZ A′. In FIG. 6, the ANSATZ A corresponds to the DAG 125B in FIG. 1, and the ANSATZ A′ corresponds to the output ANSATZ DAG 130A.

The probability that a tensor will be in A and will also be in A′ is depicted in a heatmap color palette where a white center means that there is probability equal to 1 that it will be in the final ANSATZ A′ (e.g., the modified ANSATZ DAG 130B from FIG. 1) and a black center means zero probability. Then, the prediction of the graph neural network function G is [symbol] , which has continuous values on the node properties:

$$= G ( m , D )$$

Because G's outputs are the probabilities between 0 and 1, it is desirable to use loss functions appropriated to these values as a logistic regression (or something similar) (L₁). Some tools such as convolutional layers or other dimensionality reduction techniques can be used on the implementation of G, since the dimensions of inputs and outputs are large graphs. During the formulation of the loss function, service 105 can use an auxiliar guidance loss function (L₂, that can just be a function that sums the node and edge attributes of a DAG) to reduce the number of elements that have attributes equal to 1 on final [symbol] . Then, the final loss is:

$$Loss = {L}_{1} ( {D}^{′} , ) + {L}_{2} ( )$$

Then, service 105 will use data collected from the previous step to train the graph neural network. The use of batches of heterogeneous data in every batch is preferred. Service 105 can then facilitate the generation of a new ANSATZ.

Once service 105 has trained the model G and has a new unseen optimization problem with Hamiltonian representation H, service 105 can input m and D from the original ANSATZ A to obtain \tilde{D}′. This output can then be translated to a smaller ANSATZ A′ by removing gates from A, where the removed gates are ones that have a relatively low probability in D′. Service 105 can define a threshold “e”. Values on D′ that are below the threshold “e” became 0, such that fewer gates will be used to construct ANSATZ A′ as compared to the number of gates in ANSATZ A. This new ANSATZ A′ has a reduced number of gates, but it can also be reduced in terms of the number of qubits because some qubits can be disentangled by the elimination of some of the gates.

Accordingly, service 105 is able to facilitate a technique to reduce a tensor network based on machine learning model. Service 105 can also implement a special training procedure to facilitate this reduction. The disclosed collection data scheme also permits tensor networks to be implemented in a reduced version or form. Consequently, service 105 helps generate a compressed representation of quantum circuits via the usage of artificial intelligence (AI) having the objective to reduce a tensor network.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

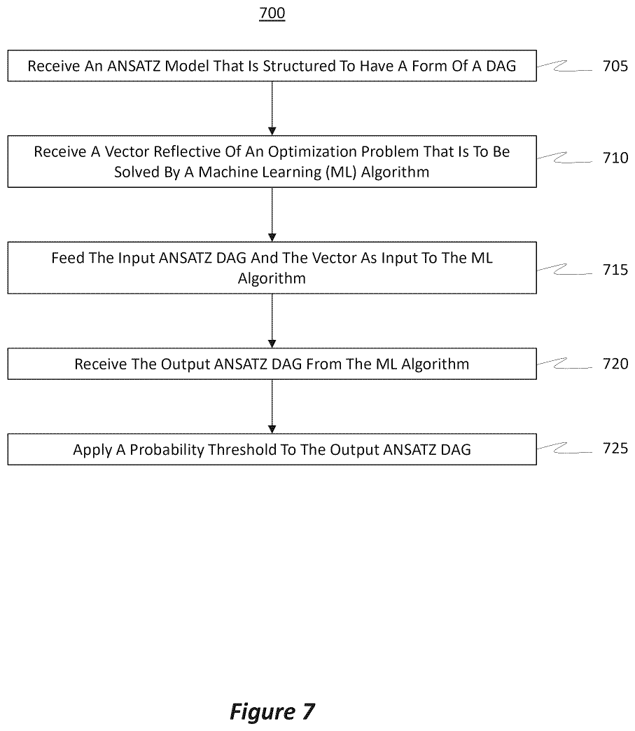

Attention will now be directed to FIG. 7, which illustrates a flowchart of an example method 700 for using machine learning to decrease overparameterization so as to determine which gates of a quantum circuit are of relatively higher importance and to cull the lesser relevant gates from the circuit. Method 700 can be implemented within architecture 100 of FIG. 1. Also, method 700 can be performed by service 105.

Method 700 includes an act (act 705) of receiving an ANSATZ model that is structured to have a form of a directed acyclic graph (DAG). The DAG is an input ANSATZ DAG and includes a plurality of nodes and a plurality of edges.

Act 710 includes receiving a vector reflective of an optimization problem that is to be solved by a machine learning (ML) algorithm. The optimization problem identifies one or more parameters related to the ANSATZ model. The optimization problem also relates to optimizing the one or more parameters.

Act 715 includes feeding the input ANSATZ DAG and the vector as input to the ML algorithm. The process of feeding the input ANSATZ DAG and the vector to the ML algorithm triggers the ML algorithm to attempt to optimize the one or more parameters by assigning, using the vector, probabilities to the plurality of nodes and the plurality of edges in the input ANSATZ DAG. Notably, the probabilities reflect whether corresponding tensors will be included in an output ANSATZ DAG generated by the ML algorithm.

Act 720 includes receiving the output ANSATZ DAG from the ML algorithm.

Act 725 includes applying a probability threshold to the output ANSATZ DAG, resulting in removal of one or more nodes and one or more edges from the output ANSATZ DAG. The removed nodes and edges are removed as a result of those removed nodes and edges having probabilities that are below the probability threshold. This removal process also results in the generation of a modified ANSATZ DAG that includes fewer nodes and edges than the input ANSATZ DAG.

In some implementations, the output ANSATZ DAG is formatted as a heatmap to reflect the probabilities. For instance, different colors in the heatmap can represent different probabilities. Also, different shades for the colors can represent the different probabilities.

Removal of the one or more nodes and the one or more edges from the output ANSATZ DAG can be performed by assigning the removed nodes and edges a probability of 0. In some cases, the nodes and edges having the probability of 0 are prevented from having gates in a quantum circuit assigned thereto. Furthermore, as a result of preventing the gates being assigned to the nodes and edges (which have the probability of 0), a number of quantum bits are disentangled, resulting in a reduced number of quantum bits being used in the quantum circuit.

In some scenarios, the ANSATZ model is a pre-defined parameterized tensor network. Also, in some scenarios, the optimization problem is a previously unseen problem having a Hamiltonian representation.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

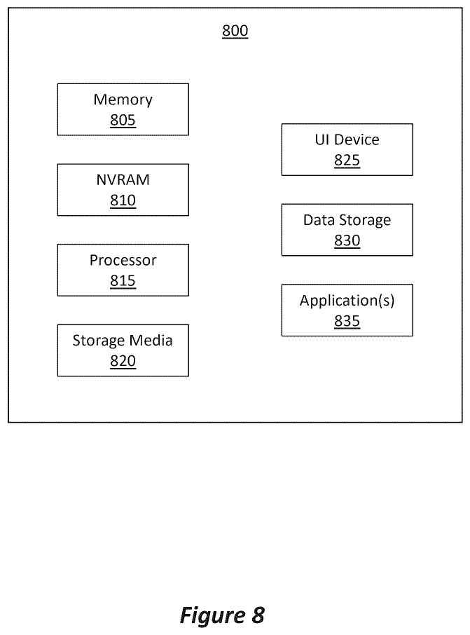

With reference briefly now to FIG. 8, any one or more of the entities disclosed, or implied, by the Figures and/or elsewhere herein, may take the form of, or include, or be implemented on, or hosted by, a physical computing device, one example of which is denoted at 800. Also, where any of the aforementioned elements comprise or consist of a virtual machine (VM), that VM may constitute a virtualization of any combination of the physical components disclosed in FIG. 8.

In the example of FIG. 8, the physical computing device 800 includes a memory 805 which may include one, some, or all, of random access memory (RAM), non-volatile memory (NVM) 810 such as NVRAM for example, read-only memory (ROM), and persistent memory, one or more hardware processors 815, non-transitory storage media 820, UI device 825, and data storage 830. One or more of the memory 805 of the physical computing device 800 may take the form of solid-state device (SSD) storage. Also, one or more applications 835 may be provided that comprise instructions executable by one or more hardware processors 815 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein. The physical device 800 may also be representative of an edge system, a cloud-based system, a datacenter or portion thereof, or other system or entity.

The disclosed embodiments can be implemented in numerous different ways, as described in the various different clauses recited below.

Clause 1. A method comprising: receiving an ANSATZ model that is structured to have a form of a directed acyclic graph (DAG), wherein the DAG is an input ANSATZ DAG and includes a plurality of nodes and a plurality of edges; receiving a vector reflective of an optimization problem that is to be solved by a machine learning (ML) algorithm, wherein the optimization problem identifies one or more parameters related to the ANSATZ model, and wherein the optimization problem relates to optimizing the one or more parameters; feeding the input ANSATZ DAG and the vector as input to the ML algorithm, wherein feeding the input ANSATZ DAG and the vector to the ML algorithm triggers the ML algorithm to attempt to optimize the one or more parameters by assigning, using said vector, probabilities to the plurality of nodes and the plurality of edges in the input ANSATZ DAG, wherein the probabilities reflect whether corresponding tensors will be included in an output ANSATZ DAG generated by the ML algorithm; receiving the output ANSATZ DAG from the ML algorithm; and applying a probability threshold to the output ANSATZ DAG, resulting in removal of one or more nodes and one or more edges from the output ANSATZ DAG, wherein the removed nodes and edges are removed as a result of those removed nodes and edges having probabilities that are below the probability threshold, and wherein said removal results in generation of a modified ANSATZ DAG that includes fewer nodes and edges than the input ANSATZ DAG.

Clause 2. The method of any of the preceding clauses, wherein the output ANSATZ DAG is formatted as a heatmap to reflect the probabilities.

Clause 3. The method of any of the preceding clauses, wherein removal of the one or more nodes and the one or more edges from the output ANSATZ DAG is performed by assigning the removed nodes and edges a probability of 0.

Clause 4. The method of any of the preceding clauses, wherein nodes and edges having the probability of 0 are prevented from having gates in a quantum circuit assigned thereto.

Clause 5. The method of any of the preceding clauses, wherein, as a result of preventing the gates being assigned to the nodes and edges having the probability of 0, a number of quantum bits are disentangled, resulting in a reduced number of quantum bits being used in the quantum circuit.

Clause 6. The method of any of the preceding clauses, wherein the ANSATZ model is a pre-defined parameterized tensor network.

Clause 7. The method of any of the preceding clauses, wherein the optimization problem is a previously unseen problem having a Hamiltonian representation.

Clause 8. A computer system comprising: one or more processors; and one or more hardware storage devices that store instructions that are executable by the one or more processors to cause the computer system to: receive an ANSATZ model that is structured to have a form of a directed acyclic graph (DAG), wherein the DAG is an input ANSATZ DAG and includes a plurality of nodes and a plurality of edges; receive a vector reflective of an optimization problem that is to be solved by a machine learning (ML) algorithm, wherein the optimization problem identifies one or more parameters related to the ANSATZ model, and wherein the optimization problem relates to optimizing the one or more parameters; feed the input ANSATZ DAG and the vector as input to the ML algorithm, wherein feeding the input ANSATZ DAG and the vector to the ML algorithm triggers the ML algorithm to attempt to optimize the one or more parameters by assigning, using said vector, probabilities to the plurality of nodes and the plurality of edges in the input ANSATZ DAG, wherein the probabilities reflect whether corresponding tensors will be included in an output ANSATZ DAG generated by the ML algorithm; receive the output ANSATZ DAG from the ML algorithm; and apply a probability threshold to the output ANSATZ DAG, resulting in removal of one or more nodes and one or more edges from the output ANSATZ DAG, wherein the removed nodes and edges are removed as a result of those removed nodes and edges having probabilities that are below the probability threshold, and wherein said removal results in generation of a modified ANSATZ DAG that includes fewer nodes and edges than the input ANSATZ DAG.

Clause 9. The computer system of any of the preceding clauses, wherein the output ANSATZ DAG is formatted as a heatmap to reflect the probabilities.

Clause 10. The computer system of any of the preceding clauses, wherein removal of the one or more nodes and the one or more edges from the output ANSATZ DAG is performed by assigning the removed nodes and edges a probability of 0.

Clause 11. The computer system of any of the preceding clauses, wherein nodes and edges having the probability of 0 are prevented from having gates in a quantum circuit assigned thereto.

Clause 12. The computer system of any of the preceding clauses, wherein, as a result of preventing the gates being assigned to the nodes and edges having the probability of 0, a number of quantum bits are disentangled, resulting in a reduced number of quantum bits being used in the quantum circuit.

Clause 13. The computer system of any of the preceding clauses, wherein the ANSATZ model is a pre-defined parameterized tensor network.

Clause 14. The computer system of any of the preceding clauses, wherein the optimization problem is a previously unseen problem having a Hamiltonian representation.

Clause 15. One or more hardware storage devices that store instructions that are executable by one or more processors to cause the one or more processors to: receive an ANSATZ model that is structured to have a form of a directed acyclic graph (DAG), wherein the DAG is an input ANSATZ DAG and includes a plurality of nodes and a plurality of edges; receive a vector reflective of an optimization problem that is to be solved by a machine learning (ML) algorithm, wherein the optimization problem identifies one or more parameters related to the ANSATZ model, and wherein the optimization problem relates to optimizing the one or more parameters; feed the input ANSATZ DAG and the vector as input to the ML algorithm, wherein feeding the input ANSATZ DAG and the vector to the ML algorithm triggers the ML algorithm to attempt to optimize the one or more parameters by assigning, using said vector, probabilities to the plurality of nodes and the plurality of edges in the input ANSATZ DAG, wherein the probabilities reflect whether corresponding tensors will be included in an output ANSATZ DAG generated by the ML algorithm; receive the output ANSATZ DAG from the ML algorithm; and apply a probability threshold to the output ANSATZ DAG, resulting in removal of one or more nodes and one or more edges from the output ANSATZ DAG, wherein the removed nodes and edges are removed as a result of those removed nodes and edges having probabilities that are below the probability threshold, and wherein said removal results in generation of a modified ANSATZ DAG that includes fewer nodes and edges than the input ANSATZ DAG.

Clause 16. The one or more hardware storage devices of any of the preceding clauses, wherein the output ANSATZ DAG is formatted as a heatmap to reflect the probabilities.

Clause 17. The one or more hardware storage devices of any of the preceding clauses, wherein removal of the one or more nodes and the one or more edges from the output ANSATZ DAG is performed by assigning the removed nodes and edges a probability of 0.

Clause 18. The one or more hardware storage devices of any of the preceding clauses, wherein nodes and edges having the probability of 0 are prevented from having gates in a quantum circuit assigned thereto.

Clause 19. The one or more hardware storage devices of any of the preceding clauses, wherein, as a result of preventing the gates being assigned to the nodes and edges having the probability of 0, a number of quantum bits are disentangled, resulting in a reduced number of quantum bits being used in the quantum circuit.

Clause 20. The one or more hardware storage devices of any of the preceding clauses, wherein the optimization problem is a previously unseen problem having a Hamiltonian representation.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving an ANSATZ model that is structured to have a form of a directed acyclic graph (DAG), wherein the DAG is an input ANSATZ DAG and includes a plurality of nodes and a plurality of edges;
receiving a vector reflective of an optimization problem that is to be solved by a machine learning (ML) algorithm, wherein the optimization problem identifies one or more parameters related to the ANSATZ model, and wherein the optimization problem relates to optimizing the one or more parameters;
feeding the input ANSATZ DAG and the vector as input to the ML algorithm, wherein feeding the input ANSATZ DAG and the vector to the ML algorithm triggers the ML algorithm to attempt to optimize the one or more parameters by assigning, using said vector, probabilities to the plurality of nodes and the plurality of edges in the input ANSATZ DAG, wherein the probabilities reflect whether corresponding tensors will be included in an output ANSATZ DAG generated by the ML algorithm;
receiving the output ANSATZ DAG from the ML algorithm; and
applying a probability threshold to the output ANSATZ DAG, resulting in removal of one or more nodes and one or more edges from the output ANSATZ DAG, wherein the removed nodes and edges are removed as a result of those removed nodes and edges having probabilities that are below the probability threshold, and wherein said removal results in generation of a modified ANSATZ DAG that includes fewer nodes and edges than the input ANSATZ DAG.

2. The method of claim 1, wherein the output ANSATZ DAG is formatted as a heatmap to reflect the probabilities.

3. The method of claim 1, wherein removal of the one or more nodes and the one or more edges from the output ANSATZ DAG is performed by assigning the removed nodes and edges a probability of 0.

4. The method of claim 3, wherein nodes and edges having the probability of 0 are prevented from having gates in a quantum circuit assigned thereto.

5. The method of claim 4, wherein, as a result of preventing the gates being assigned to the nodes and edges having the probability of 0, a number of quantum bits are disentangled, resulting in a reduced number of quantum bits being used in the quantum circuit.

6. The method of claim 1, wherein the ANSATZ model is a pre-defined parameterized tensor network.

7. The method of claim 1, wherein the optimization problem is a previously unseen problem having a Hamiltonian representation.

8. A computer system comprising:
one or more processors; and
one or more hardware storage devices that store instructions that are executable by the one or more processors to cause the computer system to:
receive an ANSATZ model that is structured to have a form of a directed acyclic graph (DAG), wherein the DAG is an input ANSATZ DAG and includes a plurality of nodes and a plurality of edges;
receive a vector reflective of an optimization problem that is to be solved by a machine learning (ML) algorithm, wherein the optimization problem identifies one or more parameters related to the ANSATZ model, and wherein the optimization problem relates to optimizing the one or more parameters;
feed the input ANSATZ DAG and the vector as input to the ML algorithm, wherein feeding the input ANSATZ DAG and the vector to the ML algorithm triggers the ML algorithm to attempt to optimize the one or more parameters by assigning, using said vector, probabilities to the plurality of nodes and the plurality of edges in the input ANSATZ DAG, wherein the probabilities reflect whether corresponding tensors will be included in an output ANSATZ DAG generated by the ML algorithm;
receive the output ANSATZ DAG from the ML algorithm; and
apply a probability threshold to the output ANSATZ DAG, resulting in removal of one or more nodes and one or more edges from the output ANSATZ DAG, wherein the removed nodes and edges are removed as a result of those removed nodes and edges having probabilities that are below the probability threshold, and wherein said removal results in generation of a modified ANSATZ DAG that includes fewer nodes and edges than the input ANSATZ DAG.

9. The computer system of claim 8, wherein the output ANSATZ DAG is formatted as a heatmap to reflect the probabilities.

10. The computer system of claim 8, wherein removal of the one or more nodes and the one or more edges from the output ANSATZ DAG is performed by assigning the removed nodes and edges a probability of 0.

11. The computer system of claim 10, wherein nodes and edges having the probability of 0 are prevented from having gates in a quantum circuit assigned thereto.

12. The computer system of claim 11, wherein, as a result of preventing the gates being assigned to the nodes and edges having the probability of 0, a number of quantum bits are disentangled, resulting in a reduced number of quantum bits being used in the quantum circuit.

13. The computer system of claim 8, wherein the ANSATZ model is a pre-defined parameterized tensor network.

14. The computer system of claim 8, wherein the optimization problem is a previously unseen problem having a Hamiltonian representation.

15. One or more hardware storage devices that store instructions that are executable by one or more processors to cause the one or more processors to:
receive an ANSATZ model that is structured to have a form of a directed acyclic graph (DAG), wherein the DAG is an input ANSATZ DAG and includes a plurality of nodes and a plurality of edges;
receive a vector reflective of an optimization problem that is to be solved by a machine learning (ML) algorithm, wherein the optimization problem identifies one or more parameters related to the ANSATZ model, and wherein the optimization problem relates to optimizing the one or more parameters;
feed the input ANSATZ DAG and the vector as input to the ML algorithm, wherein feeding the input ANSATZ DAG and the vector to the ML algorithm triggers the ML algorithm to attempt to optimize the one or more parameters by assigning, using said vector, probabilities to the plurality of nodes and the plurality of edges in the input ANSATZ DAG, wherein the probabilities reflect whether corresponding tensors will be included in an output ANSATZ DAG generated by the ML algorithm;
receive the output ANSATZ DAG from the ML algorithm; and
apply a probability threshold to the output ANSATZ DAG, resulting in removal of one or more nodes and one or more edges from the output ANSATZ DAG, wherein the removed nodes and edges are removed as a result of those removed nodes and edges having probabilities that are below the probability threshold, and wherein said removal results in generation of a modified ANSATZ DAG that includes fewer nodes and edges than the input ANSATZ DAG.

16. The one or more hardware storage devices of claim 15, wherein the output ANSATZ DAG is formatted as a heatmap to reflect the probabilities.

17. The one or more hardware storage devices of claim 15, wherein removal of the one or more nodes and the one or more edges from the output ANSATZ DAG is performed by assigning the removed nodes and edges a probability of 0.

18. The one or more hardware storage devices of claim 17, wherein nodes and edges having the probability of 0 are prevented from having gates in a quantum circuit assigned thereto.

19. The one or more hardware storage devices of claim 18, wherein, as a result of preventing the gates being assigned to the nodes and edges having the probability of 0, a number of quantum bits are disentangled, resulting in a reduced number of quantum bits being used in the quantum circuit.

20. The one or more hardware storage devices of claim 15, wherein the optimization problem is a previously unseen problem having a Hamiltonian representation.
